(19) United States
(12) Patent Application Publication
(10) Pub. No.: US 2016/0371453 A1
(43) Pub. Date: Dec. 22, 2016

(54) ANALYTICAL DATA PROCESSING FOR CONSUMER HEALTH SCORES

(71) Applicant: Healthgrades Operating Company, Inc., Denver, CO (US)

(72) Inventor: Bradley R. Bowman, Mableton, GA (US)

(73) Assignee: Healthgrades Operating Company, Inc., Denver, CO (US)

(21) Appl. No.: 15/186,467

(22) Filed: Jun. 18, 2016

Related U.S. Application Data
(60) Provisional application No. 62/182,288, filed on Jun. 19, 2015.

(51) Int. Cl. G06F 19/00

(52) U.S. Cl. CPC G06F 19/3431; G06F 19/322

(57) ABSTRACT

In non-limiting examples of the present disclosure, systems, methods and devices for assisting with generating a health score for a patient are provided. An ideal patient profile may be determined from electronic medical record and consumer data received for each of a plurality of patient profiles. Consumer data and electronic medical record data for a patient may be received. A health score for the patient may be determined based on the patient's consumer data and electronic medical record and analysis comprising calculating a sum of patient values for a plurality of factors, wherein the health score is relative to the determined ideal patient profile. One or more modifiable risk factors affecting the patient's health score may be identified based on the consumer and electronic medical record and feedback related to the one or more modifiable risk factors may be provided to the patient.

### BACKGROUND

Social, consumer and behavioral patterns play a large role in the development and progression of chronic diseases, which account for more than 75% of total healthcare spending and account for 7 out of every 10 deaths in the US annually. It has been shown in recent years that patient health can be vastly improved not only by making large changes to their lifestyle such as smoking cessation and reducing the number of drinks they consume, but also by modifying certain social, consumer, and behavioral patterns. It is estimated that preventative and proactive treatment measures that take these patterns into account could provide an annual economic savings of over $1 trillion in the US alone. However, patients are not incentivized to implement modifications to their social, consumer, and behavioral patterns because they are unaware of what changes they might make to improve their health and they do not understand the degree of impact that making even small changes to those aspects of their lives can make in their overall health.

What is needed is a system that effectively communicates changes that individuals can make in their daily lives to improve their health and a mechanism for incentivizing individuals to make those changes.

It is with respect to these and other general considerations that embodiments disclosed herein have been made. Also, although relatively specific problems may be discussed, it should be understood that the embodiments should not be limited to solving the specific problems identified in the background or elsewhere in this disclosure.

### SUMMARY

In general, the embodiments of the present application relate to determining an individual health score based on a number of factors including medical and non-medical/lifestyle factors and determining the deficit or gap between an individual's actual health score and ideal patient profile and a maximum achievable health score (e.g., an ideal health score). The ideal health score is based on a profile of a hypothetical ideal patient (e.g., the ideal patient profile) that is determined by analyzing data relating to medical and non-medical factors for a large population of actual patients (e.g., a universe) using a computer system, such as a neural network. The ideal health score is age and gender dependent and comprises at least a maximum health score for any actual patient at a particular age in the population analyzed by the system. Embodiments further relate to determining steps that individuals can take to improve their health scores, minimize a deficit between the individual's health score and the ideal health score at a particular age, and determine appropriate communications to assist patients in doing so.

### BRIEF DESCRIPTION OF THE DRAWINGS

Non-limiting and non-exhaustive examples are described with reference to the following figures:

FIG. 1 is a schematic diagram illustrating an example distributed computing environment for determining individual and ideal health scores and providing feedback to users.

FIG. 2 is a graph showing the average health score of an individual based on multiple health scores calculated for the individual over the course of their life.

FIG. 3 is a graph showing an individual's health score calculated at a set age in the individual's life in comparison with an ideal health score for that age.

FIG. 4 is a graph showing an individual's health score calculated at a set age in the individual's life in comparison with an ideal health score for that age, as well as a health score that is achievable for that individual if they make one or more recommended changes.

FIG. 5 is a chart illustrating non-modifiable factors and modifiable factors [′influencing a health score for an individual.

FIG. 6 is an exemplary method for providing feedback to an individual useful in improving their health score.

FIG. 7 and FIG. 8 are exemplary methods for providing specific feedback to an individual related to improving their health score in relation to managing chronic conditions.

FIG. 9 is a simplified block diagram of a computing device with which aspects of the present disclosure may be practiced.

FIG. 10 is a block diagram illustrating physical components (e.g., hardware) of a computing device 1000 with which aspects of the present disclosure may be practiced.

FIG. 11 is a simplified diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The various embodiments and examples described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the claims.

Generally, the present disclosure is directed to identifying at risk patients for various health events and providing those patients with information related to factors in their lives that they can modify to improve their health. In particular, an ideal patient profile may be determined by a computer neural network or other analytic computing system fed with electronic medical record and consumer data received about a plurality of actual patients. An ideal health score is determined based on the ideal patient profile. In some embodiments, the ideal health score is higher than the maximum health score at a particular age for any actual patient from the population analyzed. In some embodiments, it is not possible for an actual patient to reach the ideal health score at any particular age. Consumer data and electronic medical record data for a patient may be received. The patient's consumer and electronic medical record data may be analyzed and a patient health score relative to the ideal health score may be calculated based on that analysis. The analysis may comprise a sum of patient values for a plurality of patient health conditions. At least one modifiable risk factor that affects the patient's health score may be identified based on the consumer and electronic medical record data and feedback related to the at least one modifiable risk factor may be provided to the patient.

According to examples consumer information from a large consumer-patient body, including information from consumer data collection agencies and electronic medical record data for the consumer-patient body may be fed into an analytical data computing system. The analytical data computing system may analyze the data and determine whether one or more factors in the data are linked to increased incidences in having one or more health events (e.g., heart attack, stroke, diabetes, etc.). For example, a neural network or another analytical computing model may look at the data over time and determine that individuals that have one or more common data points (e.g., watching more than 3 hours of television a day, consuming more than 20 grams of artificial sweetener in a week, driving more than 5 miles to work on their work commute, visiting a primary care physician less than twice a year, the gender of the individual, the BMI of the individual, zip code where the individual lives, area code of the individual's phone, how many children the individual has, etc.) are more or less likely than other individuals in the reviewed sample group to have a heart attack within a set period of time.

According to examples, analytical computing models may be implemented according to the systems and methods described herein and may determine that 55 year old males in the sample group that watch more than 3 hours of television a day have a 40% increased likelihood that they will have a heart attack by the time they reach the age of 56. According to another example, the analytical computing models may determine that 35 year old females have a 200% increased likelihood that they will develop osteoporosis by the age of 40 if they have nursed two or less children and they buy at least one twelve-pack of diet soda a week. According to yet another example, the analytical computing models may determine that 37 year old females who have a tested A1C level above a certain percentage in the last six-months have a 150% increased likelihood that they will develop diabetes by the age of 38.

The analytical computing models may receive consumer data from sources such as marketing databases (e.g., Acxiom, Epsilon, Nielsen, etc.), credit agencies (e.g., Equifax, Experian, TransUnion, etc.) and social media companies (e.g., Facebook, Twitter, Instagram, etc.), among others, that contain a variety of information collected from individuals. The analytical computing models may also receive electronic medical record information for individuals, alone or in combination with individuals' consumer data. For example, depending on the information available, the analytical computing models may receive consumer data for an individual from Acxiom and Experian along with electronic medical record information for the individual from one or more healthcare providers such as diagnosis and/or billing codes for one or more medical conditions associated with that individual. According to other examples the analytical computing models may receive only consumer data from one or more sources for an individual or only electronic medical record information from one or more health care providers for an individual.

Consumer data that may be received by system may include data related to categories such as: email, mobile device, social, automotive, financial services, insurance, non-profit, political, retail, telecom, travel and entertainment, games, video, etc. Data that may be received by the system in such categories may include: presence of children, age, gender, income code, estimated household net worth, address, area code, estimated household net worth, purchases made via the Internet, purchases made via phone, economic stability indication, whether an individual utilizes social networks on a mobile device, how often an individual accesses social networks (with our without a mobile device), the frequency of specific social media site use, video and picture uploads on social media, whether an individual frequents (e.g., via likes, visits, posts, etc.) business information, whether an individual is in the market for a specific type of vehicle, whether an individual is in the market for a cash or financed purchase of a vehicle, how many financial transactions an individual makes, whether an individual has shopped for banking services via the Internet, whether an individual is a full service investor or has an online trading account, whether an individual and/or has insurance, what type of insurance is carried or has been carried, whether insurance was obtained through the Internet, how long insurance has been maintained, community involvement, causes supported financially, green living lifestyle propensity, has an individual written or called any political entity, is an individual a member of a charitable organization, does an individual contribute to public broadcasting services, whether an individual is or has been engaged in fund raising activities, technological adoption, upscale store purchase history, online store purchase history, mass-merchant purchase history, whether electronics have been purchased from a website retailer store or vendor store, what cable, internet and/or cell phone companies an individual belongs to, whether an individual has shopped for or bought travel services via the Internet, frequent flyer information, number of hotel room nights stayed for leisure and business purposes in the last twelve months, affinity for different types of hotel rooms, games purchased, what kind of videogame systems are owned and whether an individual has an Internet-connected television, among others.

Electronic medical record information that may be received by the system may include data such as an individual's age, sex, height, weight, BMI, healthcare provider visit history, diagnosis codes and billing codes, among others.

According to aspects, the computer systems described herein may analyze received consumer and electronic medical record data for the multitude (e.g., hundreds of millions) of individuals that it has received such data for and determine ideal health scores. The determined ideal health score may be age and gender dependent (i.e., tailored to a patient as a way to measure the patient against a similarly situated individual) or the ideal health score may be based on the highest possible score for any individual of any age.

The systems described herein may review the received consumer and electronic medical record data and, based on pattern analysis, identify a healthiest male and a healthiest female individuals for various ages and assign a numerical value to those healthiest identified individuals that is set as the ideal health score for a person of that age and gender. For example, a health data management system may identify a 35 year old female out of hundreds of millions of others in the sample group and assign an ideal health score, based on that individual and the various data points making up the health score for her, for the entire sample group. The value assigned as the ideal health score for a 35 year old female may be set at 900, for example. According to the systems described herein, the ideal health score generally rises from a set value at the time of birth until a certain age (e.g., 30 years old) at which point the ideal health score generally falls until it reaches zero (e.g., the oldest living person's age in the sample group may be used as an indicator for the last age that is assigned a positive health score).

According to additional examples, the systems described herein may add an additional value to each ideal health score identified from the system. For example, if a determination is made that the healthiest 35 year old female in the sample group has a health score of 900, based on the consumer and electronic medical record data points making up the health score calculation, the system may assign an ideal health score of 950 for 35 year old females. Such a determination may be made, at least in part, on a computer neural network or other analytical data computing system analyzing consumer and electronic medical record data for each female in the sample group and making a determination that the identified 35 year old female has the least number of risk factors for a plurality of adverse health events (e.g., having a heart attack, having a stroke, developing osteoporosis, developing Parkinson's, Alzheimer's, developing cancers, etc.) of any 35 year old female in the sample group. According to other examples, the highest score for any individual (i.e., any age and sex) in the sample group may be set to 1000. The highest score for any individual in the sample group may set to other values (e.g., 100, 10,000, etc.) and the values assigned to various data points and patterns therein making up a health score for an individual may be adjusted accordingly.

According to aspects the systems described herein may identify a patient in the sample group and determine that, based on their own consumer and/or electronic medical record information, as well as an analytical computing model's analysis of the totality of data for each individual in the sample group, that the identified patient has one or more non-modifiable risk factors (e.g., family history and genetics, condition, number of family members, degree of relatedness to family members, etc.) and one or more modifiable risk factors (e.g., diagnosis, conditions and procedures; lifestyle and habits; quality and utilization of medical care; money spent on healthcare) for having one or more adverse health event and/or developing one or more adverse health condition in a set period of time (e.g., one month, one year, two years, etc.) or over the course of their life. Using these data points the system may calculate an individual health score for the patient. The calculated individual health score is relative to a determined ideal health score for individuals of the same or similar age (e.g., within one week, one month, one year, etc.) as the individual and is based on designated values for each of the data points that relate to the risk factors identified by an analytical computing model of the system for having each of the adverse health events and developing each of the health conditions that the analytical computing model has identified patterns for in the sample group.

According to additional examples, in addition to determining non-modifiable and modifiable risk factors for an individual, the systems described herein may also stratify individuals in the sample group into health tiers based on their individually calculated health scores. For example, the systems may put individuals having a health score from 500 to 1000 in a well (e.g., low risk chronic) tier, individuals having a health score from 400 to 499 in a chronic care management tier and individuals having a health score from 300 to 399 in a complex health tier. These tiers may be used by the systems described herein to broadly provide tailored feedback to individuals in each group that may be helpful in improving each of their health scores, and as a result their overall health.

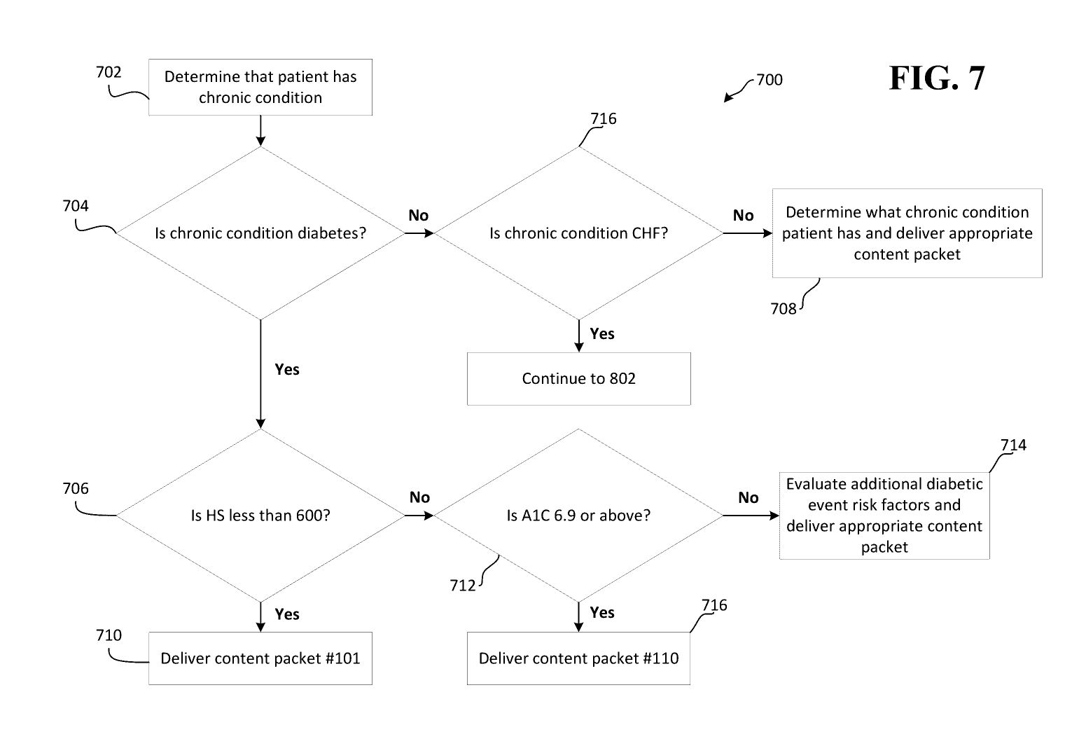

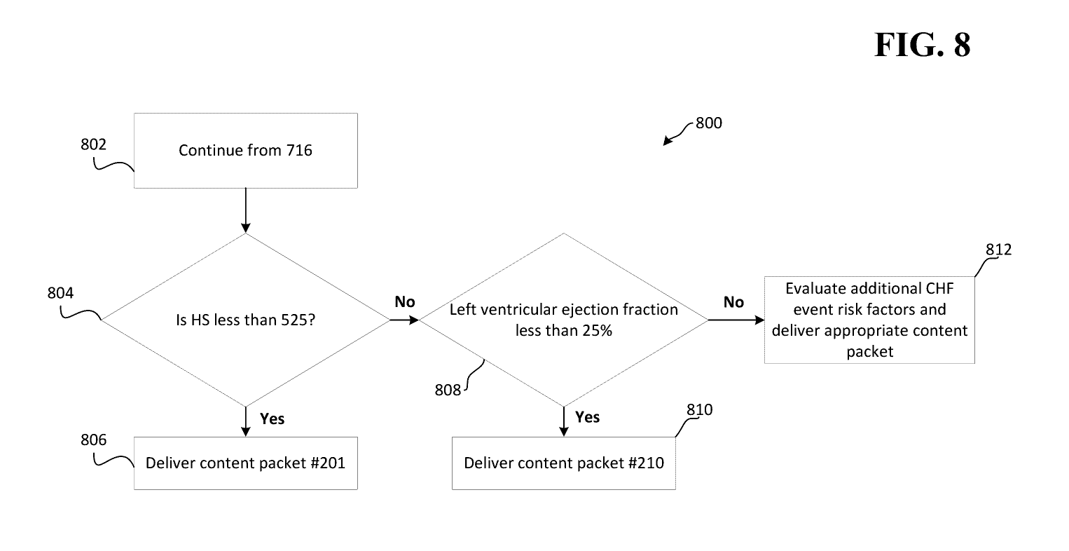

In addition to broadly providing feedback to individuals in stratified tiers as described above, the systems described herein may be utilized to provide personalized feedback to patients in the sample group. For example, a set of rules may be implemented such that information specific to a patient may be analyzed, in combination with their calculated health score, and appropriate feedback provided regarding identified modifiable risk factors they might influence to improve their individual health score and as a result their overall health, as more fully described below with reference to FIG. 7 and FIG. 8. According to additional examples, patients may be provided with feedback that shows them to what extent they can improve their individual health score by implementing recommended changes, thereby incentivizing individuals to implement said recommended changes.

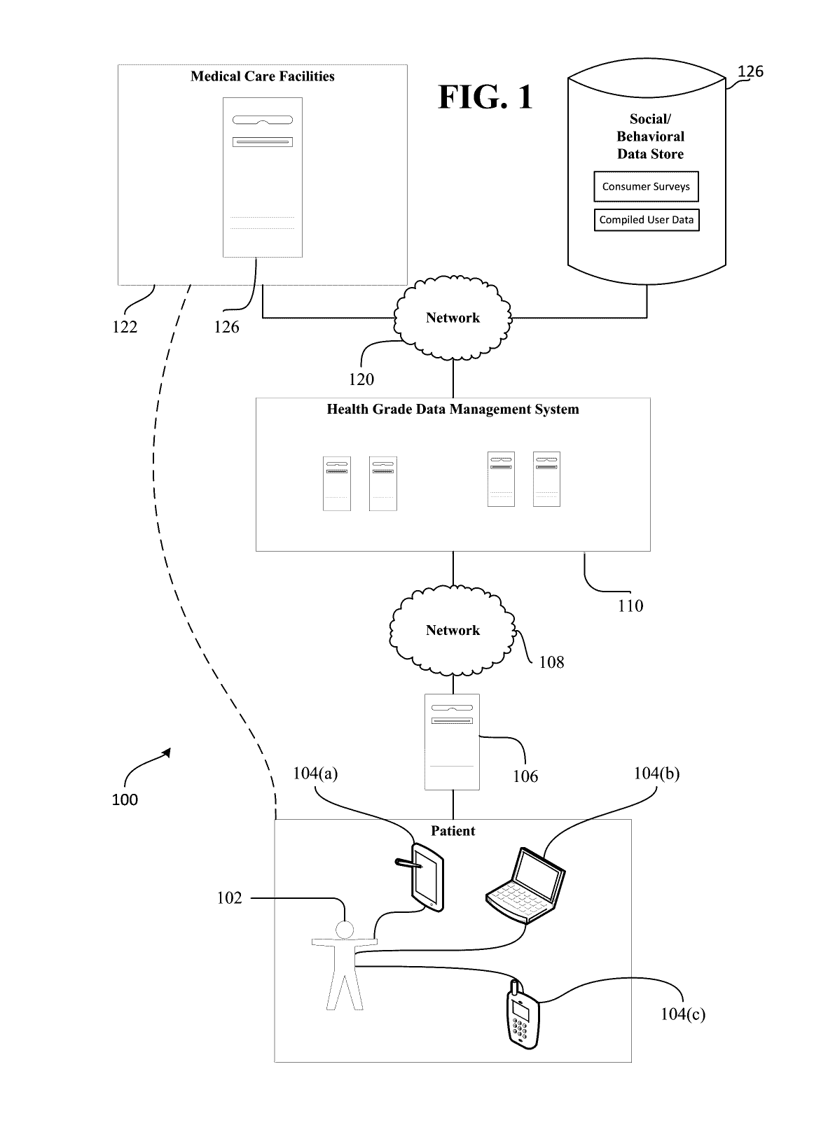

Turning to FIG. 1 a schematic diagram 100 illustrating an example distributed computing environment for determining individual and ideal health scores and providing feedback to users is provided. Patient 102 may be cared for by one or more medical care facilities 122 which store patient 102's medical record information about patient 102 such as visit dates, procedures performed, sex, age, weight, billing and insurance codes, diagnosis codes, etc., in a database 126 containing patient 102's electronic medical record Patient 102 has access to one or more computing devices 104(a), 104(b) and 104(c) through which he may perform consumer tasks such as online shopping and banking, as well as connect with other individuals via social media and other computing and Internet resources. Patient 102 may connect to these resources via server 106 and Network 108, which allow patient 102 to access the Internet.

Information input on computing devices 104(a), 104(b) and 104(c) may be stored in a social/behavioral data store 126, which may comprise information about patient 102 collected by big data consumer providers such as Acxiom, Epsilon and Nielsen. Information stored in social/behavioral data store 126 may include information such as the patient 102's age, gender, relationship status, number of household members, number of children, ages of household members and children, estimated income, credit score, online shopping history, political associations and social media behaviors, among others.

Health data management system 110 may include one or more computing devices (e.g., servers) for evaluating information in the patient 102's electronic medical record 126, as well as consumer information about the patient 102. The patient 102's electronic medical record information and consumer information may be sent from the medical care facilities 122 and the social/behavioral data store 126 to the health data management system via network 120 for data processing. Health data management system 110 may include one or more analytic data computing system such as computer neural networks for performing processing the received data. According to one example, the health data management system 110 may include an artificial neural network such as back propagation neural network for processing the received data. Such networks may estimate or approximate functions that can depend on a large number of inputs and generate useful results comprised of identified patterns generated from the inputs.

According to examples, patient 102 may be just one of hundreds of millions of patients whose electronic medical record information and consumer information is sent to health data management system 110. Thus, health data management system 110 and its corresponding analytical data computing system may process billions or even trillions of pieces of information about a large sample group or population of patient-consumers. Health data management system 110 may evaluate the received data and determine whether there are patterns therein that implicate one or more medical care and/or consumer-lifestyle factors as being associated with an increased probability of an individual having an adverse health event or developing an adverse health condition. For example, health data management system 110 may evaluate the electronic medical record 126 of every patient in the sample group having an electronic medical record 126 available and look for one or more indicators (e.g., procedure code, billing code, insurance code, diagnosis code, etc.) that a patient has had an adverse health event such as a heart attack or stroke, for example. The health data management system 110 may then evaluate additional data received for the patients for which it has been determined that the indicated adverse health event has occurred and determine whether patterns amongst such patients indicate that one or more health and/or consumer-lifestyle factors are associated with an increased probability of having that adverse health event.

According to examples, in addition to finding patterns in the sample group data indicative of risk factors for health events and adverse health conditions, health data management system 110 may provide a health score for a single patient, such as patient 102. In order to do so, health data management system 110 may first determine an ideal health score for a patient of the same or similar age as patient 102 and the same sex as patient 102. According to one example, health data management system 110 may evaluate each patient in the sample group of the same sex as patient 102 and being within one day, one week, one year, etc. of the same as patient 102 and evaluate all of the health and consumer data available for each of those patients. The health data management system 110 may then find the individual from that group having the best health and assign a health score to that person (e.g., 100, 1000, 10,000, etc.). That health score is then set as the ideal heath score for a person of the same or similar age and the same sex.

In addition to determining an age and sex dependent ideal health score, the system may evaluate the risk factors it has identified for various health conditions and health events, and assign scores to those risk factors such that deductions to patient 102's health score may be applied appropriately when generating a health score for patient 102. Similarly, the health data management system 110 may determine that certain patterns in the information obtained from the sample group are indicative in decreasing the likelihood of having one or more health events or developing one or more health conditions and the health data management system 110 may assign values to those factors which may also be integrated into the health score of a patient.

According to some examples, in addition to assigning a health score to patient 102, health data management system 110 may also make a determination as to which of the factors (i.e., data points corresponding to health and consumer information) associated with patient 102 may be modified by patient 102 to improve their health, and which of those factors are non-modifiable. Upon so determining, health data management system 110 may send feedback via network 108 to the patient 102 which indicates their individual health score, the ideal health score for an individual of their age and sex, and categorized modifiable and non-modifiable risk factors that impact their individual health score. In addition, health data management system 110 may also provide feedback to patient 102 that indicates how making changes to the modifiable factors can improve their individual health score at that point in time in relation to the ideal health score, as well as how making those changes is likely to impact their individual health score as they continue to age. In addition to providing feedback to patient 102, the health data management system 110 may also engage in an ongoing dialogue with patient 102 about improving their individual health score as well as other health-related topics. For example, health data management system 110 may actively listen for patient responses, analyze those responses, update health scores, and respond with new, updated messages.

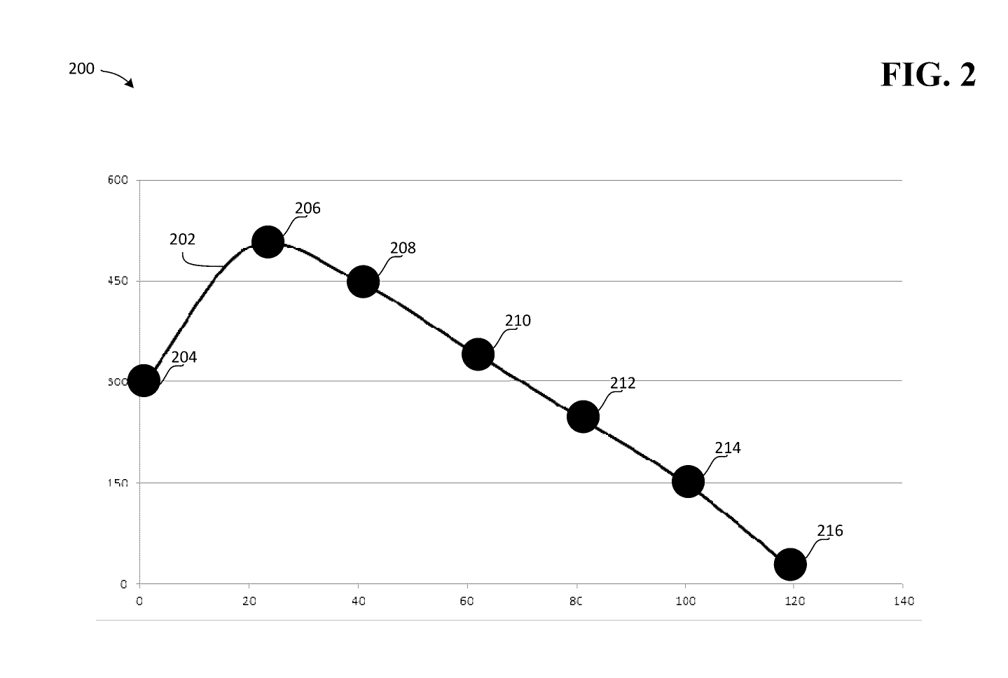

FIG. 2 is a graph 200 showing the average health score 202 of a patient, such as patient 102, based on multiple health scores 204, 206, 208, 210, 212, 214 and 216 calculated for the patient over the course of their life. Graph 200 contains an X-axis which represents the patient's age over the course of their life and a Y-axis which corresponds to a health score. At 204 a first data point corresponding to a health score for a patient is shown. The first health score 204 has been generated at the patient's date of birth and the average health score gradually increases from that point in time until a second health score 206 is generated for the patient when they are 20 years of age. From age 20 until age 120 (the date of death for this patient) the average health score 202 gradually decreases from its high point at 20 years of age until it reaches zero when the patient dies. A third health score 208, a fourth health score 210, a fifth health score 212, a sixth health score 214 and a seventh health score 216 have been generated for the patient at the ages of 40, 60, 80, 100 and 120, respectively and are used as data points upon which the average health score 202 for the patient is based.

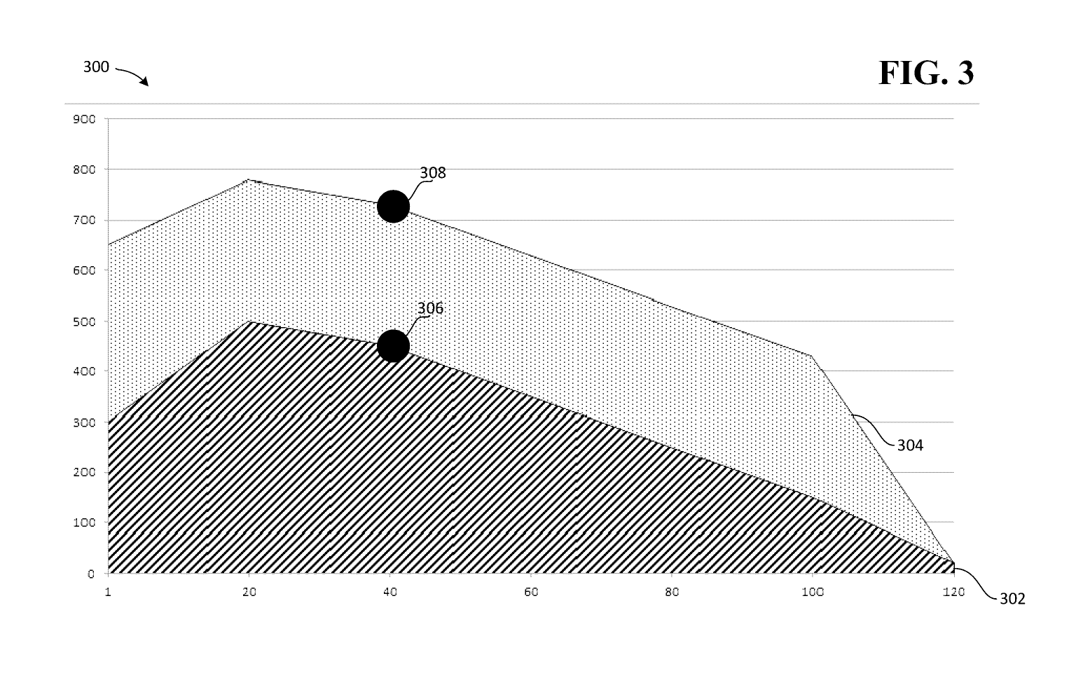

FIG. 3 is a graph 300 showing a health score 306 for a patient, such as patient 102, that is calculated at the age of 40. The health score 306 is shown in relation to an ideal health score 308 based on an ideal profile of a person of the same age and sex as the patient. Graph 300 includes an X-axis corresponding to age and a Y-axis corresponding to health score. Graph 300 also includes a projected health score 302 for the patient during the course of their life and a health gap 304 that follows the patient's life and indicates what the ideal health score is for an individual of the same age and sex as the patient.

According to some examples one or more digital health signatures may be created by analyzing, categorizing and scoring the components that uniquely comprise each patient's health gap. Components for each health gap are first characterized by their state of permanence or modifiability. Further sub-classification may assign each component to one or more axes comprising: family history and genetics (FHx); diagnosis, conditions and procedures (DCP); lifestyle and habits (LH); quality and utilization (QU); and cost ($).

A sub-score may be calculated for each axis, which allows for:
Population risk stratification by axis (i.e., diagnosis, conditions and procedures; lifestyle and habits, etc.)
Identify the greatest health gap reduction opportunities for each individual, or the population as a whole
Prioritize intervention opportunities for planning and forecasting
Targeting communications to the appropriate individuals and groups
Measure clinical and behavioral outcomes

Identification and classification of the modifiable factors within the sum of the health gaps or total health deficit of the population provides the following advantages:
More robust stratification models
Richer individual profiles
Better matching individual needs to communication assets
Insights into soft targets vs. those that are more resistant to modification
Better understanding into the sustainability and permanence for specific behavior changes and the level of the follow-up support required

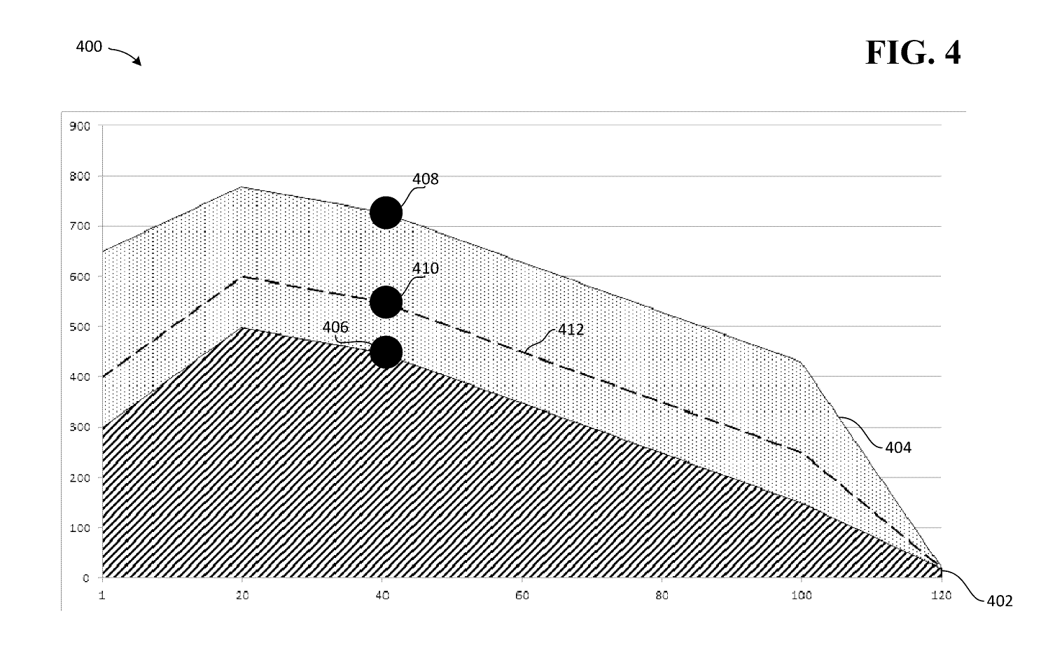

FIG. 4 is a graph 400 showing a patient's health score 406 calculated at the age of 40 in relation to an ideal health score 408 for a person of the same age and sex as the patient, as well as a projected achievable health score 410 for the patient should they make changes to one or more modifiable health and/or social-behavioral factors identified by the health data management system described herein. Graph 400 also includes a projected health score 402 for the patient during the course of their life and a health gap 404 that follows the patient's life and indicates what the ideal health score for an individual of the same and sex as the patient is. Graph 400 also includes an ideal projected health score 412 demonstrating how the patient's health score may be improved during the course of their life if they make one or more changes to the modifiable risk factors identified by the health data management system described herein. In this way the patient may be graphically incentivized to proactively make changes to modifiable factors identified by the system, improving their health and reducing health care costs associated with managing one or more health conditions during the course of their life.

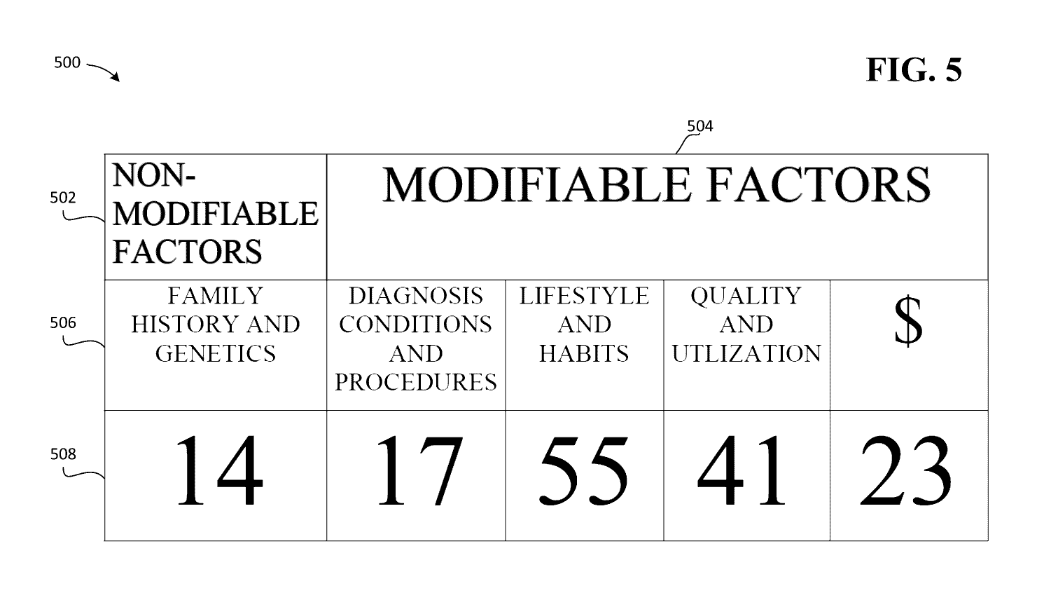

FIG. 5 is a chart 500 illustrating non-modifiable factors 502 and modifiable factors 504 identified by the health data management system for a patient that influence the patient's health score is shown. The identified factors are provided only by way of example and others may, alone or in combination with shown identified factors in FIG. 5 are contemplated in accordance with the present disclosure and as more fully discussed below. At 506 the non-modifiable factors 502 identified for the patient are shown alongside the modifiable factors 504 identified for the patient. The identified non-modifiable factors 502 include family history and genetics 506. The identified modifiable factors include diagnosis, conditions, and procedures, lifestyle and habits, quality and utilization and cost ($). The respective number 508 of identified non-modifiable factors 502 and modifiable factors 504 by category are also shown in the chart. According to this example chart, the health data management system has identified 14 non-modifiable factors 502 falling under family history and genetics category 506. The health data management system has also identified 136 modifiable risk factors 504 for the patient, including 17 in the diagnosis conditions and procedures category, 55 in the lifestyle and habits category, 41 in the quality and utilization category, and 23 in the cost ($) category.

Examples of non-modifiable factors that may fall under the family history and genetics category may include a type of health condition or health event that the patient's family member or family members have a history of, the number of family members that have had one or more health condition or health event, and the degree of relatedness to that family member or family members, among others.

Examples of modifiable factors that may fall under the diagnosis, conditions and procedures category may include a type of health condition or health event that the patient has been diagnosed with, whether a diagnosed health event or health condition is acute or chronic, and whether a diagnosed health event or health condition is permanent, semi-permanent or transient, among others.

Examples of modifiable factors falling under the lifestyle and habits category may include risk factors identified by the system for one or more health events or health conditions, weighted severity of the identified risk factors, and pro-health behaviors that the patient may engage in, among others.

Examples of modifiable factors falling under the quality and utilization category may include healthcare quality measures undertaken in the patient's care, the degree to which accountable care organizations are involved in the patient's care, the level of preventative care taken by the patient, the patient's utilization of health services, and predicted utilization of health services by service line and level of care for the patient, among others.

Examples of modifiable factors under the cost ($) category may include predicted total healthcare costs in the next year for the patient, the actual cost of healthcare for the patient in the last year, and whether healthcare costs for the patient are as expected, more than expected or less than expected, among others.

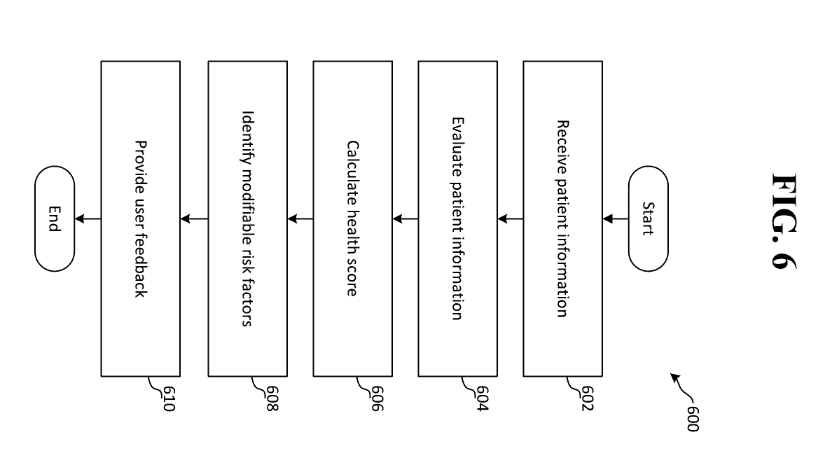

At FIG. 6 an exemplary method 600 for providing feedback to patients useful in improving their health score is provided. The method 600 begins at operation 602 where patient information is received by the health data management system. As discussed above, patient information received by the health data management system may include information from the patient's electronic medical record and/or consumer data as shown in FIG. 1. At operation 604 the received patient information is evaluated by the health data management system. Evaluation of the received patient information may include identifying patient factors that are correlated with the patient having an adverse health event (e.g., heart attack, stroke, etc.). Evaluation of the received patient information may also include identifying patient factors that are correlated with the patient developing an adverse health condition (developing cancer, developing osteoporosis, etc.).

Moving to operation 606 an individual health score is calculated for the patient. Calculation of the individual health score may include analyzing the identified factors determining, in relation to an ideal health score for a person of the same or approximately the same age (within one week, one month, one year) and same sex, values for each of those factors, and determining a combined score comprising each of the values associated with each of the identified factors. Moving to operation 608 the health data management system identifies one or more modifiable factors for the patient. The modifiable factors include factors that the patient may make changes to in order to improve their health score. At 610 the patient is provided with feedback related to their health score. Such feedback may include their individual health score, a projected health score over time, the ideal health score for a person of the same age and the same sex as the patient, the identified modifiable factors, one or more projected health scores indicating a projection of what their health score may be if they make a change related to an identified modifiable risk factor and a stratification of the patient into a risk tier based on their health score (e.g., well and low risk chronic, chronic care management, complex, etc.), among others.

According to some examples, providing feedback to a patient may include a sophisticated clinical, force-ranking algorithm that generates a personalized ToDo list for each patient. What separates this from simple patient registries and dashboards is that it will determine which issues warrant the most immediate and future attention. Further, this will help keep patients focused on their most important issues while providing the necessary data to automate the identification, queuing and timing of the delivery of targeted communications that support clinical encounters and manage inter-visit care.

FIG. 7 and FIG. 8 illustrate exemplary methods 700 and 800 for providing specific feedback to an individual related to improving their health score in relation to managing chronic conditions. Beginning at operation 702 a determination is made by the health data management system that a patient has a chronic condition. This determination may be made by, for example, analyzing the patient's electronic medical record and identifying a diagnosis code, a billing code related to a chronic condition, an insurance code, etc.

Flow then moves to operation 704 where a determination is made as to whether the patient's chronic condition is diabetes. If the patient's chronic condition is determined to be diabetes flow moves to operation 706 where a determination is made as to whether the patient's health score is less than 600. If a determination is made that the patient's health score is determined to be less than 600, flow continues to operation 710 where a content packet #101 is delivered to the patient. According to examples, the content packet may include information regarding identified modifiable and non-modifiable factors affecting their health score and their chronic condition. The content packet may provide recommendations regarding improving their health score as it relates to the chronic condition, as well as recommendations that may help improve their overall health.

Moving back to operation 706, if the patient's health score is determined to be 600 or more, flow moves to operation 712 where a determination is made as to whether the patient has a recent A1C result of 6.9 or above. According to examples, this determination may be made by the health data management system reviewing data in the patient's electronic medical record. According to other examples, the patient may be prompted by the health data management system to answer whether they have had an A1C test done recently, and if so, what the result was. If a determination is made that the patient has had a recent A1C result of 6.9 or above, flow continues to operation 716 where a different packet #110 is delivered to the patient. The delivered packet may include information regarding modifiable and non-modifiable factors influencing the patient's health, as well as ways in which the patient may improve their health and their individual health score. Moving back to operation 712, if a determination is made that the patient has not had a recent A1C test done with a result of an A1C level of 6.9 or above, flow moves to operation 714 where additional diabetic event risk factors are evaluated and an appropriate packet, in relation to identified patient risk factors and their health score, is provided to the patient.

Moving back to operation 704, if a determination is made that the patient's chronic condition is not diabetes, flow moves to operation 716 where a determination is made as to whether the patient's chronic condition is congestive heart failure (CHF). If a determination is made that the patient's chronic condition is not CHF flow continues to operation 708 where a determination is made as to what chronic condition the patient has and an appropriate packet is delivered to the patient. If at operation 704 a determination is made that the patient's chronic condition is CHF, flow continues to operation 802 shown in FIG. 8.

At operation 802 flow is continued from operation 704 and the method continues to operation 804 where a determination is made as to whether the patient's health score is less than 525. If a determination is made that the patient's health score is less than 525, a content packet #201 is delivered to the patient. If a determination is made that the patient's health score is not less than 525 flow continues to operation 808 where a determination is made as to whether the patient's left ventricular ejection fraction is less than 25%. If a determination is made that the patient's left ventricular fraction is less than 25% flow moves to operation 810 where content packet #210 is delivered to the patient. If a determination is made that the patient's left ventricular ejection fraction is not less than 25% flow continues to operation 812 where addition CHF event risk factors are evaluated and an appropriate content packet is delivered to the patient.

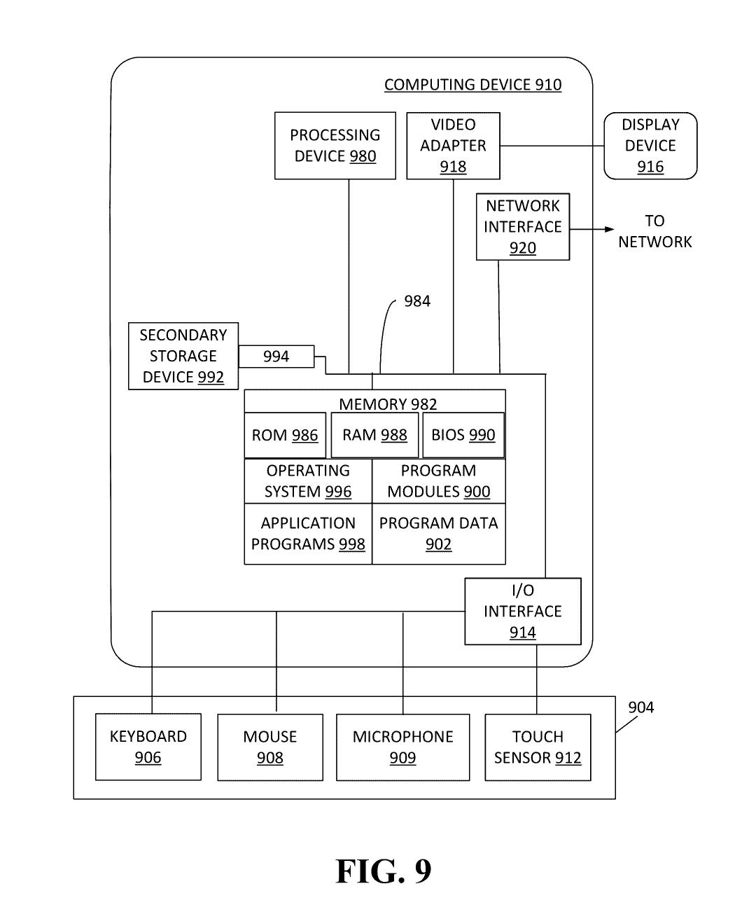

The methods of FIG. 8 and FIG. 9, and other similar methods that may be applied in accordance with the systems and methods described herein, may apply an algorithm that has at its disposal a database of rules that utilize demographic, claims, electronic medical records, a health reimbursement arrangement, pharmacy, laboratory and biometric data to identify “clinically relevant” situations and teachable moments and opportunities for patient engagement. Identification rules may be as simple as “males of a certain age” or “all diabetics,” as complicated as “type 2 diabetics on metformin, with diabetic nephropathy who are not on an ACEI or ARB,” and everything in between.

Additional sample Identification Rules for Diabetes include:

1. If (diagnosed with Type 1 diabetes)

2. If (diagnosed with Type 2 diabetes)

3. If (((diagnosed with Type 1)∥(diagnosed with Type 2)) && (tobacco use))

4. If (((diagnosed with Type 1)∥(diagnosed with Type 2)) && (sedentary lifestyle))

5. If (((diagnosed with Type 1)∥(diagnosed with Type 2)) && (diagnosed with metabolic syndrome))

6. If (((diagnosed with Type 1)∥(diagnosed with Type 2)) && (diagnosed with diabetic retinopathy))

7. If (((diagnosed with Type 1)∥(diagnosed with Type 2)) && (diagnosed with coronary artery disease))

8. If (((diagnosed with Type 1)∥(diagnosed with Type 2)) && (diagnosed with congestive heart failure))

9. If (((diagnosed with Type 1)∥(diagnosed with Type 2)) && (diagnosed with diabetic nephropathy))

10. If (((diagnosed with Type 1)∥(diagnosed with Type 2)) && (last A1c test performed>=12 mo ago))

11. If (((diagnosed with Type 1)∥(diagnosed with Type 2)) && (last dilated eye exam performed>=12 mo ago))

12. If (((diagnosed with Type 1)∥(diagnosed with Type 2)) && (last foot exam performed>=12 mo ago))

13. If (((diagnosed with Type 1)∥(diagnosed with Type 2)) && (last urine protein test performed>=12 mo ago))

14. If (((diagnosed with Type 1)∥(diagnosed with Type 2)) && (last lipid profile performed>=12 mo ago))

15. If ((((diagnosed with Type 1)∥(diagnosed with Type 2)) && ((last A1c test performed<12 mo ago) && (last A1c test result>9%)))

16. If ((((diagnosed with Type 1)∥(diagnosed with Type 2)) && ((last A1c test performed<12 mo ago) && (last A1c test result<=7%)))

17. If (((diagnosed with Type 1)∥(diagnosed with Type 2)) && (diagnosed with hypertension))

18. If (((diagnosed with Type 2) && (BMI>=27) && (BMI<30)))

19. If ((diagnosed with Type 2) && (BMI>=30))

20. If ((diagnosed with Type 1) && (BMI>=27))

21. If (((diagnosed with Type 1)∥(diagnosed with Type 2)) && ((last LDL test<12 mo ago)∥(last HDL test<=12 mo age)) && ((LDL test result>=100 mg/d1)∥(last HDL test <=40mg/d1)))

22. If (((diagnosed with Type 1)∥(diagnosed with Type 2)) && ((last triglycerides test<12 mo ago) && (last triglycerides test>=150 mg/d1)))

23. If ((diagnosed with Type 2) && (prescribed insulin))

24. If (prescribed oral hypoglycemic)

25. If ((((diagnosed with Type 1)∥(diagnosed with Type 2)) && ((diagnosed with hypertension)∥(diagnosed with nephropathy)) && ((prescribed ACEI)∥(prescribed ARB))))

26. If ((((diagnosed with Type 1)∥(diagnosed with Type 2)) && ((diagnosed with hypertension)∥(diagnosed with nephropathy)) && ((not prescribed ACEI)∥(not prescribed ARB))))

27. If (((diagnosed with Type 1)∥(diagnosed with Type 2)) && && ((prescribed diuretic)))

According to additional examples, each identification rule may be linked to one, or many, discussion topics that are clinically or behaviorally relevant. For example: nutrition and foot care are very relevant topics to all diabetics, whereas parathyroid hormone monitoring for diabetics with chronic kidney disease is relevant to a select subpopulation.

Each topic may be addressed by a variety of content types. For example, nutrition may include recipes, shopping lists, cooking classes, quizzes, reminders, motivational stories, news stories and feature stories (e.g., glycemic index 101, spotting the hidden fat, etc.).

The identification rules and the algorithm are useful in informing the sequence and timing of all communications, thereby shaping the programming and the patient experience.

Sample discussion topics for diabetes include:
Screenings & Immunizations
Diabetes News
Diabetes Nutrition
Diabetes Exercise
Diabetes—Blood Sugar Monitoring
Diabetes and Smoking
Diabetes and Weight Control
Diabetes and Obesity
Diabetes and Metabolic Syndrome
Diabetes A1C Reminder
Diabetes Healthy Tips
Type 1 Diabetes
Type 2 Diabetes
Diabetes Good Control
Diabetes Poor Control
Diabetes and Lipid Monitoring
Diabetes and Elevated Lipids
Diabetes and Blood Pressure Monitoring
Diabetes and High Blood Pressure
Aspirin and Diabetes
Diabetes Dilated Eye Exam
Diabetes Foot Exam
Diabetes Kidney Screening
Insulin Basics
Oral Agents FAQs
Advanced Insulin Management
Diabetes and Kidney Disease
Diabetes Hypertension or Nephropathy Not On ACE or ARB
Diabetes Hypertension or Nephropathy On ACE or ARB Monitoring
Diabetic Retinopathy
Diabetes and Coronary Artery Disease
Diabetes and Congestive Heart Failure
Complete Lipid Profile Annual Reminder
Urine Protein Test Annual Reminder
Regular Blood Pressure Check Reminder
Diabetic Neuropathy
Diabetic Foot Care
Diabetes and Pregnancy
Managing Sick Days
Diabetes and Depression
Diuretics Potassium and Creatinine Monitoring
ACEI or ARB Potassium and Creatinine Monitoring
Chronic Kidney Disease Calcium Monitoring
Chronic Kidney Disease Parathyroid Hormone Monitoring
Chronic Kidney Disease Phosphorus Monitoring
Medication Reminder

Sample targeting rules for diabetes that link information packets to identification rules include:
Rule 10: if (diabetes), then deliver content packet #107 (self-monitoring) [priority level 70] [do not disturb 3 days] [timeout 30 days], go to rule 32
Rule 32: if (diabetes and hypertension), then deliver content packet #125 (hidden salt) [priority level 75] [do not disturb 1 day], go to rule 73
Rule 73: if (congestive heart failure or left ventricular systolic dysfunction), then deliver content packet #325 (weight reminder) [priority level 85] [do not disturb null], repeat every 3 days, go to rule 85.

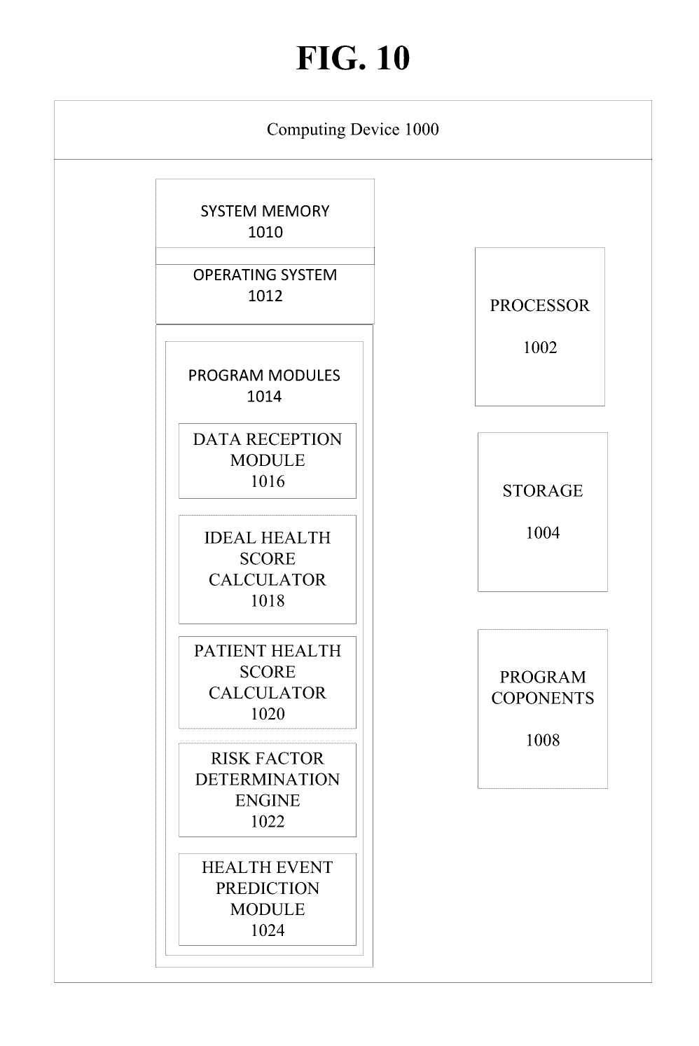

FIG. 9 illustrates one aspect in which an exemplary architecture of a computing device according to the disclosure that can be used to implement aspects of the present invention, including any of the plurality of computing devices described herein with reference to the various figures. The computing device illustrated in FIG. 16 can be used to execute the operating system, application programs, and software modules (including the software engines) described herein, for example, with respect to FIG. 10 and program modules 1014, data reception module 1016, interrogation management module 1018, missed report engine 1020, due report engine 1022 and auto-calibration engine 1024. By way of example, the computing device 910 will be described below as the remote monitoring computing device 910. To avoid undue repetition, this description of the computing device will not be separately repeated herein for each of the other computing devices described herein and shown in the accompanying figures.

The computing device 910 includes, in some embodiments, at least one processing device 980, such as a central processing unit (CPU). A variety of processing devices are available from a variety of manufacturers, for example, Intel or Advanced Micro Devices. In this example, the computing device 910 also includes a system memory 982, and a system bus 984 that couples various system components including the system memory 982 to the processing device 980. The system bus 984 is one of any number of types of bus structures including a memory bus, or memory controller; a peripheral bus; and a local bus using any of a variety of bus architectures.

Examples of computing devices suitable for the computing device 910 include a server computer, a desktop computer, a laptop computer, a tablet computer, a mobile computing device (such as a smart phone, an iPod® or iPad® mobile digital device, or other mobile devices), or other devices configured to process digital instructions.

The system memory 982 includes read only memory 986 and random access memory 1688. A basic input/output system 990 containing the basic routines that act to transfer information within computing device 910, such as during start up, is typically stored in the read only memory 986.

The computing device 910 also includes a secondary storage device 992 in some embodiments, such as a hard disk drive, for storing digital data. The secondary storage device 992 is connected to the system bus 984 by a secondary storage interface 994. The secondary storage devices 992 and their associated computer readable media provide nonvolatile storage of computer readable instructions (including application programs and program modules), data structures, and other data for the computing device 910. Details regarding the secondary storage devices 992 and their associated computer readable media, as well as their associated nonvolatile storage of computer readable instructions (including application programs and program modules) will be more fully described below with reference to FIG. 10.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 992 or memory 982, including an operating system 996, one or more application programs 998, other program modules 900 (such as the software engines described herein), and program data 902. The computing device 910 can utilize any suitable operating system, such as Microsoft Windows™, Google Chrome™, Apple OS, and any other operating system suitable for a computing device.

In some embodiments, a user provides inputs to the computing device 910 through one or more input devices 904. Examples of input devices 904 include a keyboard 906, mouse 908, microphone 909, and touch sensor 912 (such as a touchpad or touch sensitive display). Other embodiments include other input devices 904. The input devices are often connected to the processing device 980 through an input/output interface 914 that is coupled to the system bus 984. These input devices 904 can be connected by any number of input/output interfaces, such as a parallel port, serial port, game port, or a universal serial bus. Wireless communication between input devices and the interface 914 is possible as well, and includes infrared, BLUETOOTH® wireless technology, cellular and other radio frequency communication systems in some possible embodiments.

In this example embodiment, a display device 916, such as a monitor, liquid crystal display device, projector, or touch sensitive display device, is also connected to the system bus 984 via an interface, such as a video adapter 918. In addition to the display device 916, the computing device 910 can include various other peripheral devices (not shown), such as speakers or a printer.

When used in a local area networking environment or a wide area networking environment (such as the Internet), the computing device 910 is typically connected to the network through a network interface 920, such as an Ethernet interface. Other possible embodiments use other communication devices. For example, some embodiments of the computing device 910 include a modem for communicating across the network.

The computing device 910 typically includes at least some form of computer readable media. Computer readable media includes any available media that can be accessed by the computing device 910. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 910. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 9 is also an example of programmable electronics, which may include one or more such computing devices, and when multiple computing devices are included, such computing devices can be coupled together with a suitable data communication network so as to collectively perform the various functions, methods, or operations disclosed herein.

FIG. 10 is a block diagram illustrating additional physical components (e.g., hardware) of a computing device 1000 with which certain aspects of the disclosure may be practiced. The computing device components described below may have computer executable instructions for determining an ideal health score from electronic medical record and consume data received for a plurality of patients; receiving consumer data and electronic medical record data for a patient; analyzing the patient's consumer and electronic medical record data and calculate a health score for the patient based on that analysis comprising a sum of patient values for a plurality of patient health conditions and the health score being relative to the determined ideal health score; identifying, based on the consumer and electronic medical record data, a modifiable risk factor that affects the patient's health score; and providing feedback related to the modifiable risk factor to the patient.

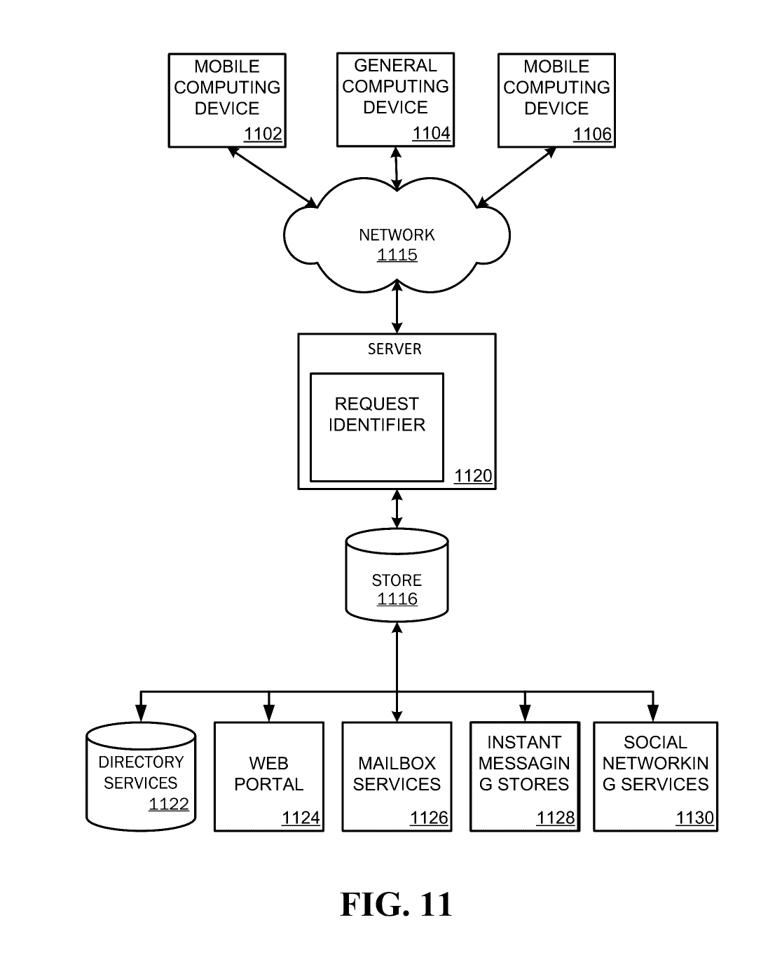

Computing device 1000 may perform these functions alone or in combination with a distributed computing network such as those described with regard to FIG. 11 which may be in operative contact with a personal computing device, a tablet computing device and/or mobile computing device which may communicate and process the one or more of the program modules described in FIG. 10 including data reception module 1016, ideal health score calculator 1018, patient health score calculator 1020, risk factor determination engine 1022 and health event prediction module 1024. According to additional examples, computing device 1000 may be in communicative contact via the distributed computing network described in FIG. 11.

In a basic configuration, the computing device 1000 may include at least one processor 1002 and a system memory 1010. Depending on the configuration and type of computing device, the system memory 1010 may comprise, but is not limited to, volatile storage (e.g., random access memory), non-volatile storage (e.g., read-only memory), flash memory, or any combination of such memories. The system memory 1010 may include an operating system 1012 and one or more program modules 1014 suitable for performing the functions described herein with regard to health score generation and analysis and data communication, such as one or more components in regards to FIG. 10 and, in particular, data reception module 1016, ideal health score calculator 1018, patient health score calculator 1020, risk factor determination engine 1022 and health event prediction module 1024. The operating system 1012, for example, may be suitable for controlling the operation of the computing device 1000. Furthermore, embodiments of the disclosure may be practiced in conjunction with a graphics library, other operating systems, or any other application program and are not limited to any particular application or system.

The computing device 1000 may have additional features or functionality. For example, the computing device 1000 may also include additional data storage device (removable and/or non-removable) such as, for example, magnetic disks, optical disks, or tape. Such additional storage is illustrated in FIG. 10 by storage 1704. Storage may also occur via the distributed computing networks described herein. For example, computing device 1000 may communicate via network 1115 in FIG. 11 and data may be stored within network servers in store 1116 and transmitted back to computing device 1000 via network 1115 if it is determined that such stored data is necessary to execute one or more functions described herein. Additionally, computing device 1000 may communicate via network 108 and network 120 in FIG. 1 and data may be stored within social/behavioral data store 126 and transmitted back to computing device 1000 via network 108 and network 120 if it is determined that such stored data is necessary to execute one or more functions described herein.

As stated above, a number of program modules and data files may be stored in the system memory 1010. While executing the processor 1002, the program modules 1014 (e.g., data reception module) may perform processes including, but not limited to, the aspects described herein. Other program modules that may be used in accordance with aspects of the present disclosure.

FIG. 11 illustrates one example of the architecture of a system for providing an application that reliably accesses target data on a storage system and handles communication failures to one or more client devices, as described above. The system of FIG. 11 may be an exemplary system related to generating health score data and providing patient feedback. Target data accessed, interacted with, or edited in association with programming modules 1014, applications 998, and storage/memory may be stored in different communication channels or other storage types. For example, various documents may be stored using a directory service 1122, a web portal 1124, a mailbox service 1126, an instant messaging store 1128, or a social networking site 1130, application programs 998, IO interface 914 and storage systems may use any of these types of systems or the like for enabling data utilization, as described herein. A server 1120 may provide storage system for use by a client operating on general computing device and mobile device(s) through network 1115. By way of example, network 1115 may comprise the Internet or any other type of local or wide area network, and client nodes may be implemented as a computing device embodied in a personal computer, a tablet computing device, and/or by a mobile computing device (e.g., mobile processing device). Any of the examples of the client computing devices described herein and shown in the accompanying figures may obtain content from the store 1116.

Having described the embodiments of the present invention with reference to the figures above, it should be appreciated that numerous modifications may be made to the present invention that will readily suggest themselves to those skilled in the art and which are encompassed in the spirit of the invention disclosed and as defined in the appended claims. Indeed, while presently preferred embodiments have been described for purposes of this disclosure, various changes and modifications may be made which are well within the scope of the embodiments presented herein. For example, the present embodiments may not be limited specifically to healthcare provider information but, instead, may be applicable to any kind of professionals, such as engineers, accountants, veterinarians, dentists, etc. Additionally, the inclusion of specific operations and the order of operations shown in the flow diagrams are provided for illustrative purposes only and, in accordance with other embodiments, steps may be removed, reordered, modified, or performed simultaneously. Furthermore, it should be appreciated that the scope of the present embodiments accommodates other operations that may be added or removed depending on the needs of the particular entity or entities implementing or using the system.

Similarly, although this disclosure has used language specific to structural features, methodological acts, and computer-readable media containing such acts, it is to be understood that the present invention defined in the appended claims is not necessarily limited to the specific structure, acts, or media described herein. The specific structure, acts, or media are disclosed as exemplary embodiments of implementing the claimed invention. The invention is defined by the appended claims.

1. An analytical data computing system comprising:
a processor; and
a memory coupled to the processor, the memory for storing instructions which, when executed by the processor, cause the processor to perform a method comprising:
receive an ideal patient profile, wherein the ideal patient profile is based on electronic medical record data and consumer data for a population of human beings;
determine an ideal health score based on the ideal patient profile;
receive consumer data and electronic medical record data for a patient;
determine a health score for the patient based on the patient's consumer data and electronic medical record data by calculating a sum of patient values for a plurality of factors, wherein the health score is relative to the determined ideal health score;
identify a modifiable risk factor that affects the patient's health score using the patient's consumer data and electronic medical record data; and
provide feedback related to the modifiable risk factor to the patient.

2. The analytical data computing system of claim 1, wherein the patient's health score is based on an age of the patient.

3. The analytical data computing system of claim 2, wherein the ideal patient profile is based on a population of human beings, each of whom has an age that is within one year of the age of the patient.

4. The analytical data computing system of claim 1 further comprising a neural network, wherein the ideal patient profile is received from the neural network.

5. The analytical data computing system of claim 4, wherein the ideal health score is automatically updated when the neural network receives a new highest value for any one of the plurality of factors.

6. The analytical data computing system of claim 1, wherein the patient's health score is automatically updated when new data is received about the patient.

7. The analytical data computing system of claim 1, wherein the ideal patient profile comprises a sum of highest values for the plurality of factors for the population of human beings.

8. The analytical data computing system of claim 1, wherein the ideal patient profile is based on the age of the patient.

9. The analytical data computing system of claim 8, wherein the ideal patient profile is a population of human beings, each of whom has an age that is within one year of the age of the patient.

10. The analytical data computing system of claim 1, further comprising analyzing compiled data from a plurality of patients to determine whether a health condition is correlated with one or more behavioral patterns.

11. The analytical data computing system of claim 1, further comprising analyzing medical data for a plurality of patients to determine whether one or more health conditions are correlated with one or more medical care patterns.

12. The analytical data computing system of claim 6, further comprising categorizing the one or more factors as non-modifiable and modifiable risk factors.

13. The analytical data computing system of claim 1, wherein providing feedback related to the modifiable risk factor to the patient comprises determining the effect of modifying a risk factor on the patient's health score and providing the patient with an estimated health score if the patient modifies the risk factor.

14. A computer-implemented method comprising:
determining, by an analytical data computing system, an ideal patient profile from electronic medical record and consumer data received for each of a plurality of patient profiles;
receiving consumer data and electronic medical record data for a patient;
using the patient's consumer data and electronic medical record data to determine one or more values for a plurality of factors for the patient;
determining a patient health score for the patient based on the one or more values for the plurality of factors, wherein the health score is relative to the determined ideal patient profile;
identifying, based on the consumer and electronic medical record data, a modifiable risk factor that affects the patient health score; and
providing feedback related to the modifiable risk factor to the patient.

15. The computer-implemented method of claim 14, wherein the modifiable risk factor is based on the age of the patient.

16. The method of claim 14, wherein providing feedback related to the modifiable risk factor to the patient comprises determining the effect of modifying a risk factor on the patient's health score and providing the patient with an estimated health score if the patient modifies the risk factor.

17. A computer-readable storage device comprising executable instructions that, when executed by a processor, cause the processor to assist with health score generation, the computer-readable medium including instructions executable by the processor for:
creating an ideal patient profile from electronic medical record and consumer data received for a plurality of human beings;
receiving consumer data and electronic medical record data for a patient;
determining a health score for the patient based on the patient's consumer data and electronic medical record data and the ideal patient profile;
identifying, based on the consumer and electronic medical record data, a modifiable risk factor that affects the patient's health score; and
providing feedback related to the modifiable risk factor to the patient.

18. The computer-readable storage device of claim 17, wherein providing feedback related to the modifiable risk factor to the patient comprises stratifying the patient into a health tier, determining that the patient has one or more chronic health conditions, and sending information to the patient based on the patient's stratification and the one or more chronic health conditions that the patient has been determined to have.

19. The computer-readable storage device of claim 18, wherein the health tier the patient is stratified into is based on their determined health score.

20. The computer-readable storage device of claim 18, wherein determining that the patient has one or more chronic health conditions is based on information in the patient's electronic medical record, the information including at least one of: a billing code, a diagnosis code, and an insurance code.
